(19) United States
(12) Patent Application Publication
(10) Pub. No.: US 2002/0057378 A1
(43) Pub. Date: May 16, 2002

(54) METHOD FOR SELECTING SIGNALS IN TELEVISION RECEIVER

(76) Inventor: JAE MO YANG, SUWON-CITY (KR)

Correspondence Address: SUGHRUE MION ZINN, MACPEAK AND SEAS, 2100 PENNSYLVANIA AVENUE NW, WASHINGTON, DC, 20037

(21) Appl. No.: 08/982,482

(22) Filed: Dec. 2, 1997

(30) Foreign Application Priority Data
Dec. 2, 1996 (KR) P 96-61080

(51) Int. Cl. H04N 5/268

(52) U.S. Cl. 348/705; 348/706

(57) ABSTRACT

A method for selecting signals in a television receiver is disclosed. A plurality of jacks which are provided in the television receiver are automatically selected one by one, and a judgment is made as to whether external video and audio signals are inputted through the selected jack. If it is found that external video and audio signals are inputted through the selected jack, then an A/V mode which receives and processes the external video and audio signals of the selected jack is set up. If it is found that external video and audio signals are inputted through none of the jacks, then a message reading “check the connection state of the external video and audio signals” is outputted, and a television mode is set up to receive television broadcast signals. That is, in a state with the plugs of external apparatuses inserted into the respective jacks, the relevant external apparatus is activated. Then an A/V mode is set up, and the relevant jack is automatically selected.

### BACKGROUND OF THE INVENTION

1. Field of the invention

The present invention relates to a television receiver having an A/V (audio/video) function. Particularly the present invention relates to a method for selecting signals in a television receiver, in which if the A/V function is selected, external video and audio signals and television broadcast signals are selectively outputted in accordance with the presence or absence of external video and audio signals which are inputted through input jacks.

2. Description of the related art

The video processing techniques have been much progressed, and an external apparatus can reproduce video and audio signals which are recorded on various recording media such as video tape, digital video disc and the like. Thus, the video and audio signals thus reproduced can be watched through a television receiver.

The reproducing apparatus modulates the video and audio signals to radio waves of a certain channel, and the television receiver receives the modulated radio waves, so that it can be watched.

In this technique, however, the reproduced video and audio signals are modulated to radio waves of a certain channel, and the television receiver demodulates them. In this process, noises are produced to give an unpleasant feeling to the user, thereby degrading the reliability of the product.

Therefore, in the external apparatus and the television receiver, an A/V function is employed, so that clean video and audio signals can be displayed.

For the A/V function, a plurality of input jacks are provided to input external video and audio signals into the television receiver. Thus a plurality of external apparatuses can be connected, and if the user selects the A/V function, the television receiver receives external video and audio signals from the external apparatus so that they can be displayed.

For example, external video and audio signals from a video cassette tape recorder, a satellite broadcast receiver, a multiplex audio broadcast decoder and the like are inputted through input jacks into the television receiver. If the user selects the A/V function, the television receiver selects the video and audio signals from the external apparatuses to output them.

The television receiver having an A/V function can have a plurality of input jacks, and the user can select one set of video and audio signals from among a plurality of sets of external video and audio signals. In this case, the user has to select the input jacks one by one manually.

That is, in a television set having an A/V function, if the user first presses the selection key, the external video and audio signals of a first jack are selected. Then if the user presses the selection key for the second time, the external video and audio signals of a second jack are selected. If the user presses the selection key for the nth time, then the external video and audio signals of an nth jack are selected and outputted.

Therefore, the user has to press the selection key many times until the desired jack is selected, and this is a troublesome task.

In an attempt to avoid such troublesome task, recently a method is devised in which if the user selects the A/V function, the jack for receiving the desired external video and audio signals is automatically detected and selected.

This conventional technique will be described referring to FIGS. 1 and 2.

FIG. 1 illustrates the conventional circuit for selecting signals. In this drawing, reference codes 1, 2 and 3 indicate switching jacks through which the external video and audio signals are inputted.

The switching jacks 1, 2 and 3 includes: jacks J1, J2 and J3 for receiving plugs (not shown in the drawing) for supplying external video and audio signals from an external apparatus; and switches SW1, SW2 and SW3 for being opened upon inserting plugs into the jacks J1, J2 and J3, and for being connected upon receiving no plugs.

Reference code 4 indicates a plug insertion detecting section for discriminating as to whether the jacks J1, J2 and J3 are plugged to the signals of the switches SW1, SW2 and SW3.

The plug insertion detecting section 4 is constituted as follows. That is, the switches SW1, SW2 and SW3 are connected to constant voltage diodes ZD1, ZD2 and ZD3, and resistors R4, R5 and R6 are respectively connected to ground capacitors C1, C2 and C3, while a power source B+ is supplied through the resistors R4, R5 and R6 to connection points between the resistors R4, R5 and R6 and the ground capacitors C1, C2 and C3.

Reference code 5 indicates a microcomputer which selects external video and audio signals in accordance with the output signals of the plug insertion detecting section 4, and controls the processing of the selected external video and audio signals.

The microcomputer 5 is connected through its input terminals IN1, IN2 and IN3 to connection points between resistors R1, R2 and R3, the ground capacitors C1, C2 and C3 and the resistors R4, R5 and R6. The microcomputer 5 outputs control signals through its output terminals OT1 and OT2. Reference code 6 indicates a stabilizing section for stabilizing the control signals which are outputted by the microcomputer 5.

The stabilizing section 6 is constituted as follows. That is, the output terminals OT1 and OT2 of the microcomputer 5 are connected through resistors R7 and R8 to constant voltage diodes ZD4 and ZD5.

Reference code 7 indicates a switching section for selecting one set of signals from among the signals of the switching jacks 1, 2 and 3 in accordance with the control signals which have been outputted from the microcomputer 5 and stabilized by the stabilizing section 6. Reference code 8 indicates a signal processing section for processing the external video and audio signals of the switching section 7 in accordance with serial data signals SDA and serial clock signals SCLK of the microcomputer 5.

In the conventional signal selecting circuit constituted as described above, the user presses the A/V key of a key inputting section (not shown in the drawing). Then at a step S1 as shown in FIG. 2, the microcomputer 5 judges as to whether the A/V mode has been selected.

If the A/V mode has been selected at the step S1, then at steps S2, S3 and S4, the microcomputer 5 judges as to whether the jacks J1, J2 and J3 are inserted into the switching jacks 1, 2 and 3 at the potential of the input terminals IN1, IN2 and IN3.

That is, if the plugs are not inserted into the jacks J1, J2 and J3 of the switching jacks, then the switches SW1, SW2 and SW3 of the switching jacks 1, 2 and 3 are all closed. Therefore, the power B+ flows through the resistors R1 and R4 and the switch SW1 to the ground, through the resistors R2 and R5 and the switch SW2 to the ground, and through the resistors R3 and R6 and the switch SW3 to the ground. Meanwhile the input terminals IN1, IN2 and IN3 of the microcomputer 5 receive a low potential.

On the other hand, if the plugs are all inserted into the jacks J1, J2 and J3 of the switching jacks, then the switches SW1, SW2 and SW3 of the switching jacks 1, 2 and 3 are all opened. Therefore, the power B+ is charged through the resistors R1, R2 and R3 into the capacitors C1, C2 and C3, and is stabilized by the constant voltage diodes ZD1, ZD2 and ZD3. Thus a high potential is supplied to the input terminals IN1, IN2 and IN3 of the microcomputer 5.

If the input terminal IN1 has a high potential at the step S2, the microcomputer 5 decides that the plug is inserted into the jack J1 of the switching jack 1. Then at a step S5, the microcomputer 5 selects the external video and audio signals which are inputted through the jack J1 (A/V1 mode).

If the input terminal IN2 has a high potential at the step S3, the microcomputer 5 decides that the plug is inserted into the jack J2 of the switching jack 1. Then at a step S6, the microcomputer 5 selects the external video and audio signals which are inputted through the jack J2 (A/V2 mode).

If the input terminal IN3 has a high potential at the step S4, the microcomputer 5 decides that the plug is inserted into the jack J3 of the switching jack 1. Then at a step S7, the microcomputer 5 selects the external video and audio signals which are inputted through the jack J3 (A/V3 mode).

Thus if the A/V1, A/V2 or A/V3 mode is selected, then the microcomputer 5 outputs control signals through the output terminals OT1 and OT2 in accordance with the selected mode.

The number of the control signals is related to the number of the jacks. There are two resistors in this invention and it is also possible to use 4 resistors. These control signals pass through the resistors R7 and R8 of the stabilizing section 6, are stabilized by the constant voltage diodes ZD4 and ZD5, and then are supplied to the switching section 7.

Then the switching section 7 selects the external video and audio signals from among the external signals of the jacks J1, J2 and J3 in accordance with the control signals of the microcomputer 5. The video and audio signals which have been selected by the switching section 7 are processed and outputted by the signal processing section 8, so that they can be watched.

If the signals inputted into the input terminals IN1, IN2 and IN3 all have a low potential at the steps S2, S3 and S4, then the microcomputer 5 judges that the plugs have not been inserted into the jacks J1, J2 and J3. Therefore at a step S8, the microcomputer 5 outputs serial data signals SDA and serial clock signals SCLK for an OSD (on-screen display).

Then the signal processing section 8 controls an internal OSD section in accordance with the serial data signals SDA and the serial clock signals SCLK of the microcomputer 5 so as to output a message, for example, “check the connection state for the external video and audio signals”.

Then at a step S9, the microcomputer 5 maintains the television mode to receive the television broadcast signals of the current channel, so that it can be displayed.

In this conventional technique, by utilizing the switching jacks which are opened or closed in accordance with the insertion or not of the plugs, a judgment is made as to whether the external video and audio signals are inputted.

Therefore, each time external video and audio signals from an external apparatus are watched, the user has to insert the plug into the switching jack.

In a state with all the plugs inserted into the switching jacks, if one of external apparatuses is to be selected to receive its video and audio signals, the relevant switching jack cannot be found, and therefore, an automatic selection becomes impossible. Therefore, the user has to press the selection keys one by one as usual to select the relevant switching jack, and this is a troublesome task.

Further, the switching jack is an expensive component, and therefore, it increases the production cost.

### SUMMARY OF THE INVENTION

The present invention is intended to overcome the above described disadvantages of the conventional techniques.

Therefore it is an object of the present invention to provide a method for selecting signals in a television receiver, in which a jack connected to external video and audio signals is selected in a state with plugs of a plurality of external apparatuses inserted into a plurality of jacks.

In achieving the above object, the present invention is characterized as follows. That is, a plurality of jacks which are provided in the television receiver are selected one by one automatically, and a judgment is made as to whether external video and audio signals are inputted through the selected jack.

If it is found that external video and audio signals are inputted through the selected jack, then an A/V mode which processes and outputs the external video and audio signals which are inputted through the selected jack is set up.

If it is found that external video and audio signals are inputted through none of the jacks, then a message “check the connection state of the external video and audio signals” is outputted, and a television mode is set up to receive television broadcast signals.

### BRIEF DESCRIPTION OF THE DRAWINGS

The above object and other advantages of the present invention will become more apparent by describing in detail the preferred embodiment of the present invention with reference to the attached drawings in which:

FIG. 1 illustrates a conventional signal selecting circuit;

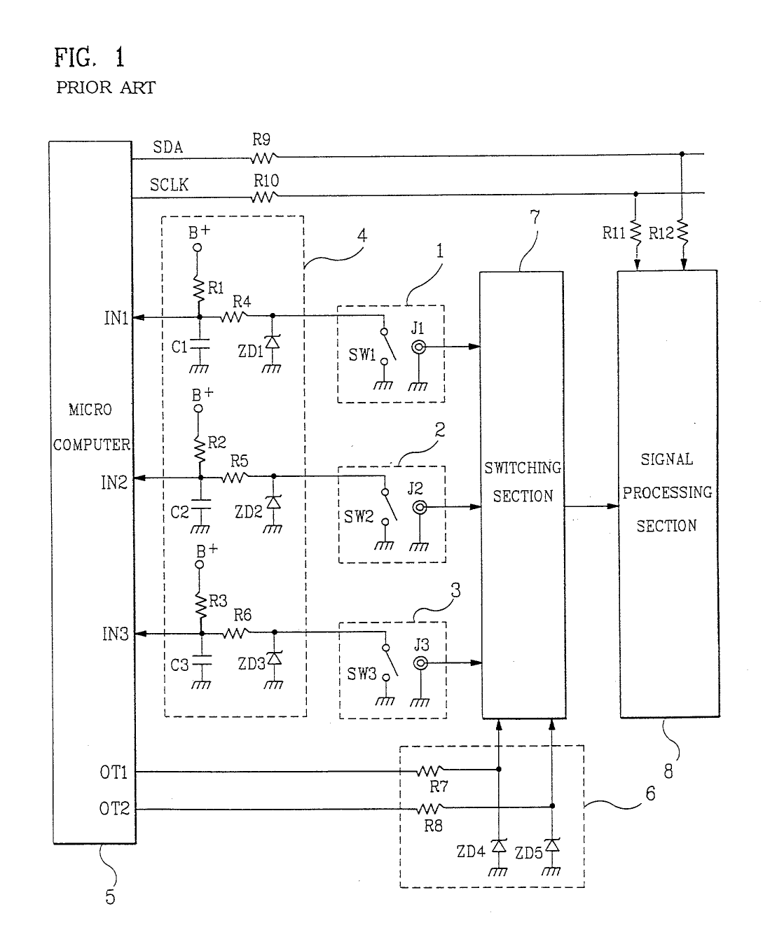

FIG. 2 is a signal flow chart showing the operation of the microcomputer of FIG. 1;

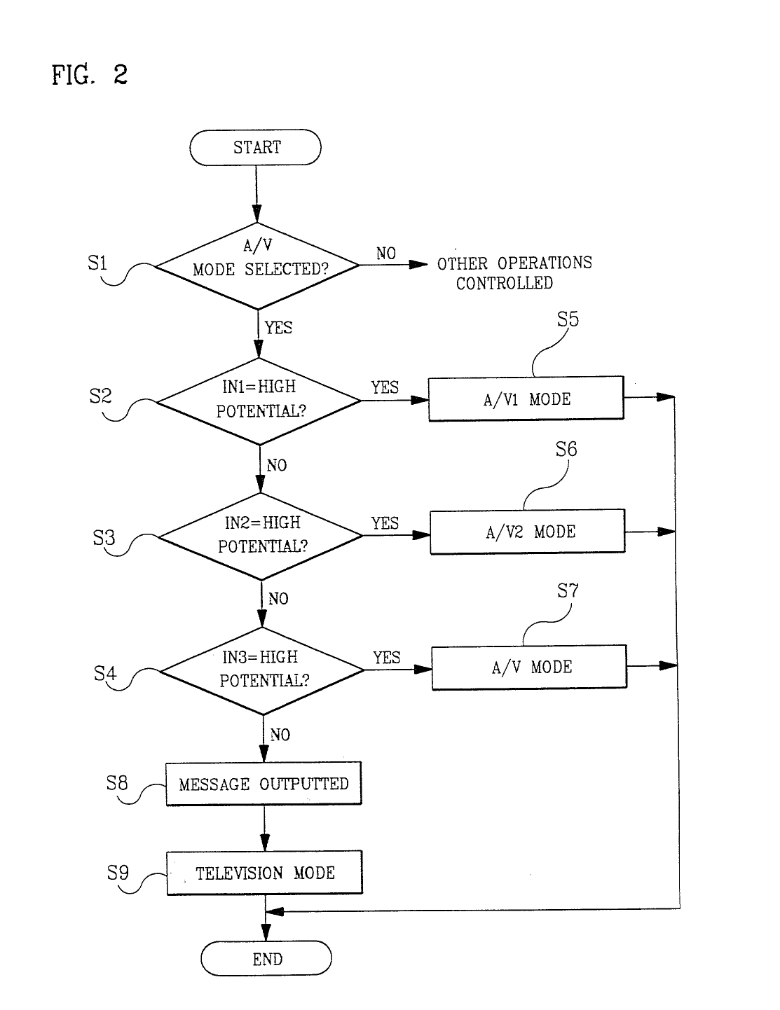

FIG. 3 illustrates the signal selecting circuit according to the present invention; and

FIG. 4 is a signal flow chart showing the operation of the microcomputer according to the present invention.

### DETAILED DESCRIPTION OF THE PREFERRED EMBODIMENT

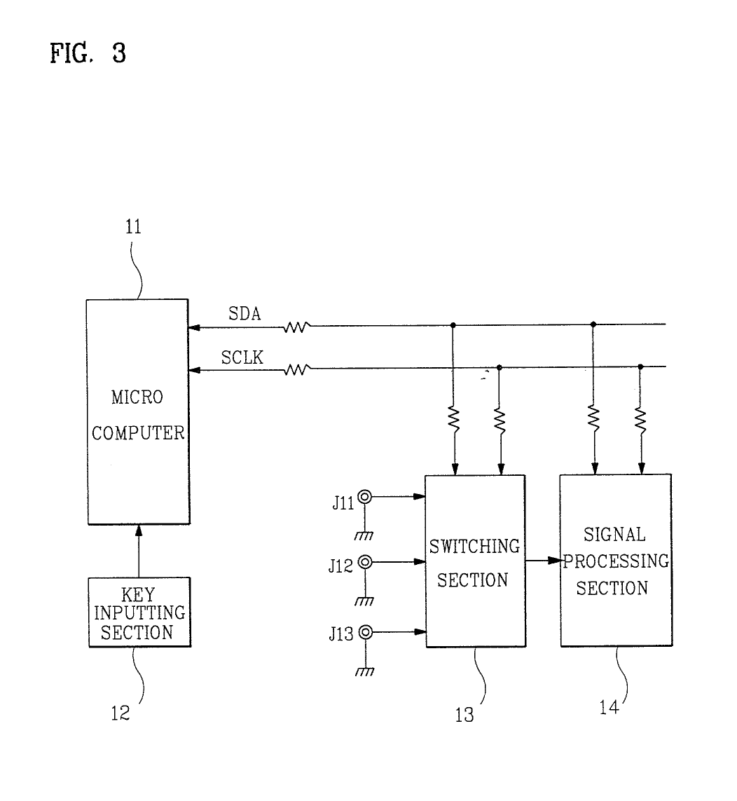

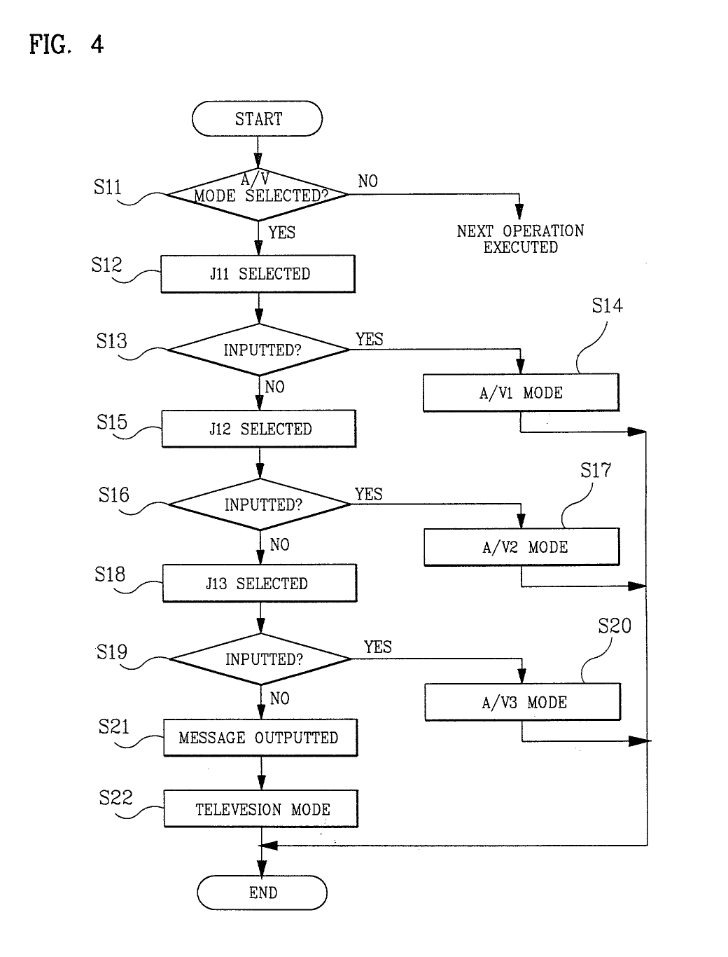

The method for selecting signals in a television receiver according to the present invention will described referring to FIGS. 3 and 4.

FIG. 3 illustrates the signal selecting circuit according to the present invention.

As shown in this drawing, the circuit according to the present invention includes: jacks J11, J12 and J13 for receiving external video and audio signals; a microcomputer 11 for judging as to the input of external video and audio signals to set up an operation mode; a key inputting section 12 for inputting working commands into the microcomputer 11 in accordance with manipulations of a user; a switching section 13 for selecting signals inputted through the jacks J11, J12 and J13 in accordance with serial data signals SDA and serial clock signals SCLK of the microcomputer 11; and a signal processing section 14 for processing output signals of the switching section 13 in accordance with the serial data signals SDA and the serial clock signals SCLK of the microcomputer 11.

Based on this circuit, the method for selecting signals in a television receiver according to the present invention will be described.

As shown in FIG. 4, at a step S11, the microcomputer 11 judges based on the key signals of the key inputting section 12 as to whether an A/V mode is set up.

If it is found that the A/V mode is set at the step S1, the microcomputer 11 selects the jack J11 at a step S12.

That is, the microcomputer 11 outputs serial data signals SDA and serial clock signals SCLK to control the switching section 13, so that the switching section 13 would input the external video and audio signals just through the jack J11.

Then at a step S13, a judgment is made as to whether the external video and audio signals are inputted through the jack J11.

That is, the microcomputer 11 outputs the serial data signals SDA and the serial clock signals SCLK to the signal processing section 14 to detect as to whether the signal processing section 14 receives the external video and audio signals from the switching section 13. Then the microcomputer 11 makes the signal processing section 14 output the serial data signals SDA, and makes a judgment based on the serial data signals SDA of the signal processing section 14 as to whether the external video and audio signals are inputted through the jack J11.

If it is found that the external video and audio signals are inputted at the step S13, then the microcomputer 11 sets up an A/V1 mode at a step S14. Thus the switching section 13 is made to continuously input the external signals through the jack J11. These signals are processed by the signal processing section 14.

If it is found that the external video and audio signals are not inputted at the step S13, then the jack J12 is selected at a step S15. Then at a step S16, a judgment is made as to whether the external video and audio signals are inputted.

If it is found that the external signals are inputted at the step S16, then an A/V2 mode is set up at a step S17, so that the external signals incoming through the jack J12 can be processed. If it is found that the external signals are not inputted at the step S16, then the jack J13 is selected at a step S18, and a judgment is made at a step S19 as to whether the external video and audio signals are inputted.

If it is found that the external signals are inputted at the step S19, then an A/V3 mode is set up at a step S20, so that the external signals incoming through the jack J13 can be processed.

If it is found that the external signals are not inputted at the step S19, then it is judged that the external video and audio signals are inputted through none of the jacks J11, J12 and J13. Then at a step S21, the signal processing section 14 is controlled by the serial data signals SDA and the serial clock signals SCLK so as to display a message (for example) “check the connection state of the external video and audio signals” in the form of an OSD. Then at a step S22, a television mode is set to receive television broadcast signals.

According to the present invention as described above, the jacks are selected in a sequential manner to judge as to whether external video and audio signals are inputted from an external apparatus. If external video and audio signals are inputted, then an operating mode of selecting the relevant jack is set up continuously.

Therefore, in the present invention, in a state with the plugs of external apparatuses inserted into the respective jacks, the external apparatus is activated, and an A/V mode is set up. Therefore the relevant jack is automatically selected, and therefore, the expensive switching jacks are not required, with the result that the production cost is saved.

What is claimed is:

1. A method for selecting signals in a television receiver, comprising the steps of:
selecting jacks (connected to external apparatuses) one by one upon encountering A/V modes (first step);
judging as to whether external video and audio signals are inputted through the jack selected at the first step (second step);
setting up an operation mode for selecting and processing the inputted external video and audio signals, if it is judged at the second step that the external signals are inputted (third step); and
setting up a television mode to receive television broadcast signals, if it is judged at the second step that external video and audio signals are inputted through none of the selected jacks (fourth step).

2. The method as claimed in claim 1, wherein, at the fourth step, a message of notifying non-inputting of the external video and audio signals is outputted, and then, the television mode is set up.
